(19) United States
(12) Patent Application Publication
(10) Pub. No.: US 2023/0259086 A1
(43) Pub. Date: Aug. 17, 2023

(54) Adaptive Knowledge-Based Energy Management System and Method

(71) Applicant: Eaton Intelligent Power Limited, Dublin (IE)

(72) Inventors: Debasmita Das, Bangalore (IN); Pranavamoorthy Balasubramanian, Pune (IN); Qiang Fu, Arvada, CO (US); Chaitanya Baone, Fremont, CA (US)

(21) Appl. No.: 17/670,957

(22) Filed: Feb. 14, 2022

(51) Int. Cl. G05B 19/042; H02J 7/00

(52) U.S. Cl. CPC G05B 19/042; H02J 7/005; H02J 7/00032; H02J 7/0048; H02J 7/0063; H02J 7/0068; H02J 7/00712; G05B 2219/2639

(57) ABSTRACT

A power controller uses a combination of dynamic state of charge limits, dynamic charge/ discharge rates, battery degradation cost and dynamic peak shave limits to identify the optimal set-points to optimally control load and generating sources while being independent of any external forecasting module. By utilizing these configurable parameters, a power controller provides optimal savings ensuring reliable and sustainable operation of a micro-grid.

### BACKGROUND

Embodiments of the disclosure relate to controlling power distribution in a microgrid.

### SUMMARY

A first aspect of the present disclosure is drawn to a power controller device for use with a battery, distributed energy resource (DER), a power distribution system (PDS), and a load. The battery is configured to operate in a battery charging mode so as to be charged by the DER and to operate in a battery discharging mode so as to discharge power to the PDS. The DER is configured to operate in a DER charging mode so as to charge the battery and to operate in a DER discharging mode so as to not charge the battery and is configured to discharge power to the PDS. The PDS is configured to provide an amount of power to the load. The power controller device includes a memory and a processor. The memory has instructions, load history data, and an economic model of the DER stored therein. The processor is configured to execute the instructions stored in the memory to cause the power controller device to: determine a dynamic peak shaving limit based on the load history data so as to have a first peak shave limit during a first period and to have a second peak shave limit during a second period; control the battery to have a dynamic state of charge (SOC) limit so as to have a first SOC limit during a third period and to have a second SOC limit during a fourth period; in a first mode of operation, transmit a power instruction signal to the DER to cause the DER to provide the amount of power to the PDS to cause the PDS to provide the amount of power to the load, based on the dynamic peak shave limit and the dynamic SOC limit; and in a second mode of operation, transmit the power instruction signal to the battery to cause the battery to provide the amount of power to the PDS to cause the PDS to provide the amount of power to the load, based on the dynamic peak shave limit and the dynamic SOC limit.

In some embodiments of this first aspect, the power controller device is for further use with a second load, wherein the PDS is further configured to provide a second amount of power to the second load. In these embodiments, the processor is configured to execute instructions stored on the memory to additionally cause the power controller device to: establish a load curtailment time period; determine whether a current time is within the curtailment time period; and transmit a curtailment instruction signal to the PDS to cause the PDS to not provide the second amount of power to the second load, when the current time is within the curtailment time period.

In some embodiments of this first aspect, the power controller device is for further use with the DER being additionally configured to have an online status or an offline status, wherein the online status enables the DER to operate in the DER charging mode or the DER discharging mode, and wherein the offline status does not enable the DER to operate in either the DER charging mode or the DER discharging mode. In these embodiments, the processor is configured to execute instructions stored on the memory to additionally cause the power controller device to: determine whether the DER is in the online status or the offline status; and transmit the power instruction signal to the battery to cause the battery to provide the amount of power to the PDS to cause the PDS to provide the amount of power to the load, when the DER is in the offline status.

In some embodiments of this first aspect, the power controller device is for further use with an external power source, wherein the external power source is configured to provide power at an external power source cost. In these embodiments, the processor is configured to execute instructions stored on the memory to additionally cause the power controller device to: compare a cost of the amount of power from the DER with the external power source cost; and transmit the power instruction signal to the DER to cause the DER to provide the amount of power to the PDS to cause the PDS to provide the amount of power to the load, when the cost of the amount of power from the DER is less than the external power source cost.

In some embodiments of this first aspect, the power controller device is for further use with the memory having a degradation model of the battery stored therein and an external power source, wherein the external power source is configured to provide power at an external power source cost. In these embodiments, wherein the processor is configured to execute instructions stored on the memory to additionally cause the power controller device to: compare a cost of degradation of the battery with the external power source cost; and transmit the power instruction signal to the battery to cause the battery to provide the amount of power to the PDS to cause the PDS to provide the amount of power to the load, when the cost of degradation of the battery is less than the external power source cost, and wherein the degradation model of the battery includes the cost of degradation of the battery.

In some embodiments of this first aspect, the power controller device is for further use with the memory having a degradation model of the battery stored therein. In these embodiments, the processor is configured to execute instructions stored on the memory to additionally cause the power controller device to: compare a cost of the amount of power from the DER with a cost of degradation of the battery, the cost of the amount of power from the DER being based on the economic model of the DER, the cost of degradation of the battery being based on the degradation model of the battery; transmit the power instruction signal to the DER to cause the DER to provide the amount of power to the PDS to cause the PDS to provide the amount of power to the load, when the cost of the amount of power from the DER is less than or equal to than the cost of degradation of the battery; and transmit the power instruction signal to the battery to cause the battery to provide the amount of power to the PDS to cause the PDS to provide the amount of power to the load, when the cost of the amount of power from the DER is greater than the cost of degradation of the battery.

A second aspect of the present disclosure is drawn to a method of using a power controller device with a battery, distributed energy resource (DER), a power distribution system (PDS), and a load. The battery is configured to operate in a battery charging mode so as to be charged by the DER and to operate in a battery discharging mode so as to discharge power to the PDS. The DER is configured to operate in a DER charging mode so as to charge the battery and to operate in a DER discharging mode so as to not charge the battery and being configured to discharge power to the PDS. The PDS is configured to provide an amount of power to the load. The method includes: determining, via a processor configured to execute instructions stored on a memory having the instructions, load history data, and an economic model of the DER stored therein, a peak shaving limit based on the load history data; determining, via a processor configured to execute instructions stored on a memory having the instructions, a dynamic peak shaving limit based on the load history data so as to have a first peak shave limit during a first period and to have a second peak shave limit during a second period; controlling, via the processor, the battery to have a dynamic state of charge (SOC) limit so as to have a first SOC limit during a third period and to have a second SOC limit during a fourth period; in a first mode of operation, transmitting, via the processor, a power instruction signal to the DER to cause the DER to provide the amount of power to the PDS to cause the PDS to provide the amount of power to the load, based on the dynamic peak shave limit and the dynamic SOC limit; and in a second mode of operation, transmitting, via the processor, the power instruction signal to the battery to cause the battery to provide the amount of power to the PDS to cause the PDS to provide the amount of power to the load, based on the dynamic peak shave limit and the dynamic SOC limit.

In some embodiments of this second aspect, the method is for further use with a second load, wherein the PDS is further configured to provide a second amount of power to the second load. In these embodiments, the method further includes: establishing, via the processor, a load curtailment time period; determining, via the processor, whether a current time is within the curtailment time period; and transmitting, via the processor, a curtailment instruction signal to the PDS to cause the PDS to not provide the second amount of power to the second load, when the current time is within the curtailment time period.

In some embodiments of this second aspect, the method is for further use with the DER being additionally configured to have an online status or an offline status, wherein the online status enables the DER to operate in the DER charging mode or the DER discharging mode, and wherein the offline status does not enable the DER to operate in either the DER charging mode or the DER discharging mode. In these embodiments, the method further includes: determining, via the processor, whether the DER is in the online status or the offline status; and transmitting, via the processor, the power instruction signal to the battery to cause the battery to provide the amount of power to the PDS to cause the PDS to provide the amount of power to the load, when the DER is in the offline status.

In some embodiments of this second aspect, the method is for further use with an external power source, wherein the external power source is configured to provide power at an external power source cost. In these embodiments, the method further includes: comparing, via the processor, a cost of the amount of power from the DER with the external power source cost; and transmitting, via the processor, the power instruction signal to the DER to cause the DER to provide the amount of power to the PDS to cause the PDS to provide the amount of power to the load, when the cost of the amount of power from the DER is less than the external power source cost.

In some embodiments of this second aspect, the method is for further use with the memory having a degradation model of the battery stored therein and an external power source, wherein the external power source is configured to provide power at an external power source cost. In these embodiments, the method further includes: comparing, via the processor, the cost of degradation of the battery with the external power source cost; and transmitting, via the processor, the power instruction signal to the battery to cause the battery to provide the amount of power to the PDS to cause the PDS to provide the amount of power to the load, when the cost of degradation of the battery is less than the external power source cost, wherein the degradation model of the battery includes the cost of degradation of the battery.

In some embodiments of this second aspect, the method is for further use with the memory having a degradation model of the battery stored therein. In these embodiments, the method further includes: comparing, via the processor, a cost of the amount of power from the DER with a cost of degradation of the battery, the cost of the amount of power from the DER being based on the economic model of the DER, the cost of degradation of the battery being based on the degradation model of the battery; transmitting, via the processor, the power instruction signal to the DER to cause the DER to provide the amount of power to the PDS to cause the PDS to provide the amount of power to the load, when the cost of the amount of power from the DER is less than or equal to than the cost of degradation of the battery; and transmitting, via the processor, the power instruction signal to the battery to cause the battery to provide the amount of power to the PDS to cause the PDS to provide the amount of power to the load, when the cost of the amount of power from the DER is greater than the cost of degradation of the battery.

A third aspect of the present disclosure is drawn to a non-transitory, computer-readable media having computer-readable instructions stored thereon, wherein the computer-readable instructions are capable of being read by a power controller device for use with a battery, distributed energy resource (DER), a power distribution system (PDS), and a load. The battery is configured to operate in a battery charging mode so as to be charged by the DER and to operate in a battery discharging mode so as to discharge power to the PDS. The DER is configured to operate in a DER charging mode so as to charge the battery and to operate in a DER discharging mode so as to not charge the battery and is configured to discharge power to the PDS. The PDS is configured to provide an amount of power to the load. The computer-readable instructions are capable of instructing the power controller device to perform the method including: determining, via a processor configured to execute instructions stored on a memory having the instructions, load history data, and an economic model of the DER stored therein, a peak shaving limit based on the load history data; determining, via a processor configured to execute instructions stored on a memory having the instructions, a dynamic peak shaving limit based on the load history data so as to have a first peak shave limit during a first period and to have a second peak shave limit during a second period; controlling, via the processor, the battery to have a dynamic state of charge (SOC) limit so as to have a first SOC limit during a third period and to have a second SOC limit during a fourth period; in a first mode of operation, transmitting, via the processor, a power instruction signal to the DER to cause the DER to provide the amount of power to the PDS to cause the PDS to provide the amount of power to the load, based on the dynamic peak shave limit and the dynamic SOC limit; and in a second mode of operation, transmitting, via the processor, the power instruction signal to the battery to cause the battery to provide the amount of power to the PDS to cause the PDS to provide the amount of power to the load, based on the dynamic peak shave limit and the dynamic SOC limit.

In some embodiments of this third aspect, the non-transitory, computer-readable media is for further use with a second load, wherein the PDS is further configured to provide a second amount of power to the second load. In these embodiments, the computer-readable instructions are capable of instructing the power controller device to perform the method further including: establishing, via the processor, a load curtailment time period; determining, via the processor, whether a current time is within the curtailment time period; and transmitting, via the processor, a curtailment instruction signal to the PDS to cause the PDS to not provide the second amount of power to the second load, when the current time is within the curtailment time period.

In some embodiments of this second aspect, the non-transitory, computer-readable media is for further use with the DER being additionally configured to have an online status or an offline status, wherein the online status enables the DER to operate in the DER charging mode or the DER discharging mode, and wherein the offline status does not enable the DER to operate in either the DER charging mode or the DER discharging mode. In these embodiments, the computer-readable instructions are capable of instructing the power controller device to perform the method further including: determining, via the processor, whether the DER is in the online status or the offline status; and transmitting, via the processor, the power instruction signal to the battery to cause the battery to provide the amount of power to the PDS to cause the PDS to provide the amount of power to the load, when the DER is in the offline status.

In some embodiments of this second aspect, the non-transitory, computer-readable media is for further use with an external power source, wherein the external power source is configured to provide power at an external power source cost. In these embodiments, the computer-readable instructions are capable of instructing the power controller device to perform the method further including: comparing, via the processor, a cost of the amount of power from the DER with the external power source cost; and transmitting, via the processor, the power instruction signal to the DER to cause the DER to provide the amount of power to the PDS to cause the PDS to provide the amount of power to the load, when the cost of the amount of power from the DER is less than the external power source cost.

In some embodiments of this second aspect, the non-transitory, computer-readable media is for further use with the memory having a degradation model of the battery stored therein and an external power source, wherein the external power source is configured to provide power at an external power source cost. In these embodiments, the computer-readable instructions are capable of instructing the power controller device to perform the method further including: comparing, via the processor, the cost of degradation of the battery with the external power source cost; and transmitting, via the processor, the power instruction signal to the battery to cause the battery to provide the amount of power to the PDS to cause the PDS to provide the amount of power to the load, when the cost of degradation of the battery is less than the external power source cost, wherein the degradation model of the battery includes the cost of degradation of the battery.

In some embodiments of this second aspect, the non-transitory, computer-readable media is for further use with the memory having a degradation model of the battery stored therein. In these embodiments, the computer-readable instructions are capable of instructing the power controller device to perform the method further including: comparing, via the processor, a cost of the amount of power from the DER with a cost of degradation of the battery, the cost of the amount of power from the DER being based on the economic model of the DER, the cost of degradation of the battery being based on the degradation model of the battery; transmitting, via the processor, the power instruction signal to the DER to cause the DER to provide the amount of power to the PDS to cause the PDS to provide the amount of power to the load, when the cost of the amount of power from the DER is less than or equal to than the cost of degradation of the battery; and transmitting, via the processor, the power instruction signal to the battery to cause the battery to provide the amount of power to the PDS to cause the PDS to provide the amount of power to the load, when the cost of the amount of power from the DER is greater than the cost of degradation of the battery.

### BRIEF SUMMARY OF THE DRAWINGS

The accompanying drawings, which are incorporated in and form a part of the specification, illustrate example embodiments and, together with the description, serve to explain the principles of the disclosure. In the drawings:

FIG. 1 illustrates a generalized version of an example algorithm to be executed by a processor to control power distribution within a microgrid in accordance with aspects of the present disclosure;

FIG. 2 illustrates an example microgrid employing a power controller in accordance with aspects of the present disclosure;

FIG. 3 illustrates an exploded view of the power controller of FIG. 2;

FIG. 4 illustrates instruction modules within the power management program, within the memory of the power controller of FIG. 3;

FIG. 5 illustrates a portion of a more detailed example algorithm to be executed by a processor to control power distribution within a microgrid in accordance with aspects of the present disclosure;

FIG. 6 illustrates a second portion of the more detailed example algorithm of FIG. 5;

FIG. 7 illustrates a third portion of the more detailed example algorithm of FIG. 5;

FIG. 8 illustrates an example load control algorithm to be executed by a processor to control power distribution within a microgrid in accordance with aspects of the present disclosure; and

FIG. 9 illustrates a graph detailing a field result test of a processor to control power distribution within a microgrid in accordance with aspects of the present disclosure.

### DETAILED DESCRIPTION

A microgrid is a self-sufficient energy system that serves a discrete geographic footprint, such as a college campus, hospital complex, business center, or neighborhood. Within microgrids are one or more kinds of distributed energy resources (DERs), such as solar panels, wind turbines, combined heat & power, generators, that produce its power. A microgrid takes into account the renewables, battery energy storage resources, diesel generators for emergency supply and/or integration with the national grid. The intermittent nature of renewables, different tariff structure and ancillary services of grid, need for uninterrupted electricity supply and carbon emission reduction make the operation of microgrid critical and complex.

What is needed is a system and method for controlling power distribution from DERs, energy discharged from a battery, and the charging of a battery within a microgrid, to optimize power provided by the DERs in a microgrid.

A system and method in accordance with the present disclosure controls power distribution from DERs, energy discharged from a battery, and the charging of a battery within a microgrid, to optimize power provided by the DERs in a microgrid.

A system and method in accordance with the present disclosure provides a real-time forecast-independent knowledge-based control of a microgrid. The system and method provide optimal set points to distributed energy resources to achieve an economic and reliable operation for both grid connected and off-grid microgrids.

While estimating dispatch set points, the system and method considers: system specifications; renewable availability; real time load for both, critical and non-critical loads; and site specific grid services and operation expenses reduction techniques. The system includes a power controller that executes instructions in a memory. The instructions may be described as being organized into multiple modules, including: a grid status identification module; a dynamic peak shave limit determination and adjustments module; modeling of DERs based on carbon emission rate module, a mathematical economical model of DERs module, a renewable optimization module; a load control module; a dynamic SOC limits module; and a rate of charge and discharge of battery module. With the combination of these modules, the power controller enables the microgrid to participate and prioritize operational expense reduction techniques.

As will be described in greater detail below, a method in accordance with aspects of the present disclosure includes eight steps. In step one (1), the DERs are mathematically modeled. In step two (2), a peak shaving limit is identified. In step (3), the resiliency of the microgrid is determined based on the DERs. In step four (4), priority is given to the DERs over existing off-grid services. In step five (5), the load is controlled. In step six (6), renewable power sources are maximized. In step seven (7), the energy peak is shaved. In step eight (8), energy arbitrage is performed.

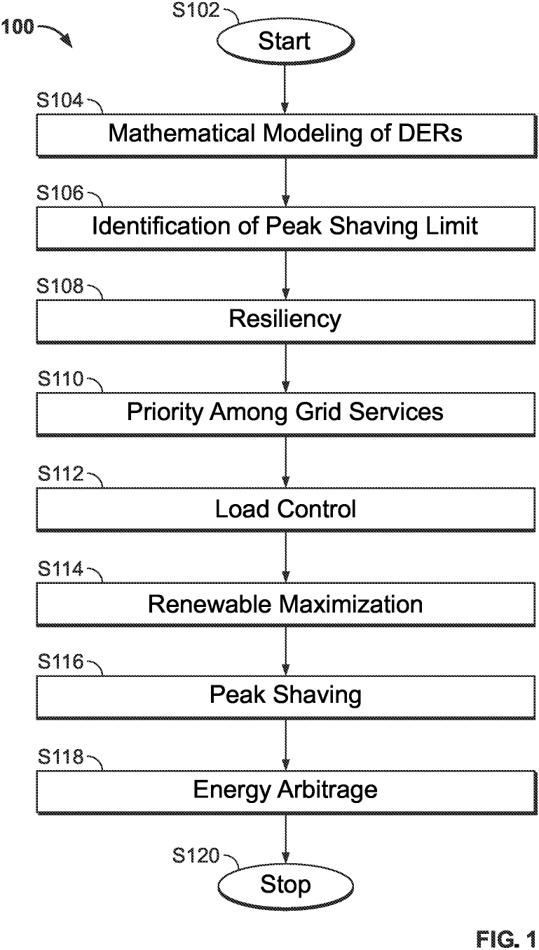

An example system and method for optimizing power from DERs in a microgrid in accordance with aspects of the present disclosure will now be described in greater detail with reference to FIGS. 1-8.

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

FIG. 1 illustrates a generalized version of an example algorithm 100 to be executed by a processor to control power distribution within a microgrid in accordance with aspects of the present disclosure.

As shown in the figure, algorithm 100 starts (S102), and the DERs are mathematically modeled (S104). As will be described in more detail below, a controller executes instructions in a memory to consider economic models of any DERs in the microgrid. Some non-limiting examples of economic models include: fuel consumption versus loading of diesel generator; the amount of power that may be provided by each DER, such as power per gallon of diesel fuel from a diesel generator, or the amount of power per lumens from a photovoltaic system; degradation model of a battery; environmental impacts (carbon emission rates) of DERs; etc.

Then, the peak shaving limit is identified (S106). In the energy industry, peak shaving refers to leveling out peaks in electricity use for all consumers. During high demand, natural gas companies will essentially reduce the amount of power consumption at small increments to avoid peak loads. Here, as will be described in more detail below, a controller executes instructions in a memory to identify a limit to the peak shaving. For example, the controller may establish a peak shaving limit of 20%, meaning that the utility service will only need to supply 80% of the power and the remaining 20% will be provided by either the battery or the DERs.

In accordance with aspects of the present disclosure, the controller selects a best method to identify peak shaving limit within a predetermined time. Some non-limiting examples of a predetermined time include a month and season. The controller may select the best method to identify the peak shaving limit by using historical data to determine the peak electrical usage, such as collected from previous electricity bills or previously measured historical electrical data. The collected data itself may be collected to include: a moving average of a predetermined number of previous months, the same month from a previous year, a month from the same season, or combinations thereof. Non-limiting examples of method of identifying the peak shaving limit include: assigning a percentage of the maximum demand and indicated from the collected data; choosing a predetermined n^{th} peak within a month - for example if there are 4 peaks within a month, choosing the third peak value; and determining a standard deviation of the peak value within the collected data.

Then, the resiliency of the microgrid is determined (S108). As will be described in more detail below, a controller executes instructions in a memory to determine the online/offline status of the DERs within the microgrid. Based on availability of the DERs, the controller may estimate optimal set points. If a utility is not providing power, i.e., this is an off-grid microgrid, then based on a cost of electricity, the controller will set a priority among available DERs which can provide power. Then the controller will access power from DERs based on their respective cost of electricity.

Then, priority is established among the grid services (S110). As will be described in more detail below, a controller executes instructions in a memory to provide flexibility in prioritizing among power provided by the DERs, the battery and grid services. This prioritizing may be based on measurable parameters such as carbon emission reduction and operational expenses reduction techniques.

Then the load is controlled (S112). As will be described in more detail below, a controller executes instructions in a memory to provide flexibility in real time load control. Non-limiting examples of real time load control include implementing load curtailments, HVAC temperature control, lighting control, etc. A load curtailment is when a load is prevented from being implemented. For example, a load curtailment may take the form of preventing a particular machine from operating between 8:00 pm and 8:00 am, when workers will not be at a facility. In this way, the overall expected load experienced by a microgrid is more controlled.

Then the renewable DERs are maximized (S114). As will be described in more detail below, a controller executes instructions in a memory to calculate the available renewable power based on weather conditions for a photovoltaic system or a windmill, if respective sensor data is available. In other embodiments, the controller may execute instructions in the memory to implement a mathematical model to calculate the available renewable power based on historical metered data. In an example embodiment, priority is giving to renewable power, whenever renewable power is available that will be used for serving the load. If the available renewable energy is more than load, then the battery may be charged with excess power.

Then peak shaving is performed (S116). As will be described in more detail below, a controller executes instructions in a memory to send a dispatch command to the battery if the net load exceeds the peak shaving threshold. A state of charge (SOC) limit of the battery for peak shaving may be adjusted by the controller based on the priority of the battery. More specifically, if the battery has priority over power provided by any of the DERs, then the battery will provide the needed power to account for the peak shaving. In instances where peak shaving is the most critical component, a minimum SOC for peak shaving will be set as actual minimum limit of SOC of the battery in order to fully use the battery charge.

Then energy arbitrage is performed (S118). As will be described in more detail below, a controller executes instructions in a memory to take advantage of a time of use (TOU) tariff of a utility power. The controller may execute instruction to enable reduction of utility power consumption during a high tariff hour and enable battery charging or connection of non-critical loads to the grid during low tariff hours in a day.

At this point algorithm 100 stops (S120).

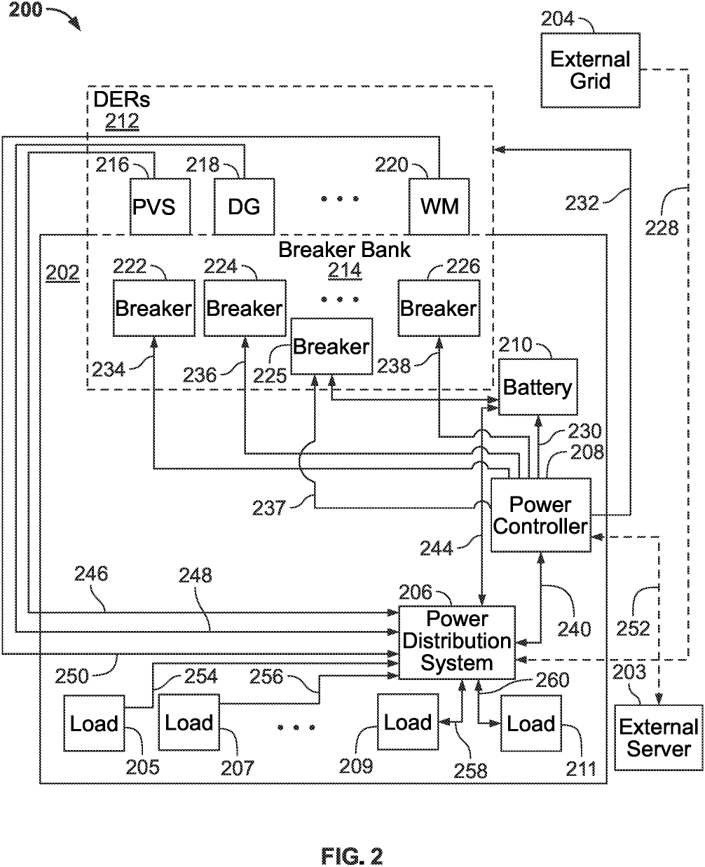

While algorithm 100 is a generalized version to be executed by a processor to control power distribution within a microgrid in accordance with aspects of the present disclosure, a more detailed algorithm will now be described with additional reference to FIGS. 2-7.

FIG. 2 illustrates an example microgrid 200 employing a power controller in accordance with aspects of the present disclosure.

As shown in the figure, microgrid 200 includes a facility 202, having a plurality of DERs 212, a sample of which includes a photovoltaic system (PVS) 216, a diesel generator 218, and a windmill 220. Facility 202 houses a power distribution system (PDS) 206, a power controller 208, a battery 210, and a breaker bank 214, a sample of which includes a breaker 222, a breaker 224, a breaker 225, and a breaker 226. Facility 202 additionally includes a plurality of loads, a sample of which includes a load 205, a load 207, a load 209 and a load 211. Microgrid 200 may additionally, optionally, be connected to an external grid 204 by way of an optional power line 228. Further, microgrid 200 may optionally be in communication with an external server 203 via a communication channel 252.

Power controller 208 is configured to communicate with battery 210 via a communication channel 230, to communicate with DERs 212 via a communication channel 232, to communicate with breaker 222 via a communication channel 234, to communicate with breaker 224 via a communication channel 236, to communicate with breaker 226 via a communication channel 238, to communicate with breaker 225 via a communication channel 237, and to communicate with PDS 206 via a communication channel 240. Further, in instances where microgrid 200 is optionally connected to external server 203, power controller 208 is configured to communicate with external server 203 via communication channel 252.

Each of DERs 212 is additionally configured to provide power to PDS 206. For example, PVS 216 is configured to provide power to PDS 206 via a power line 246. Diesel generator 218 is configured to provide power to PDS 206 via a power line 248. Windmill 220 is configured to provide power to PDS 206 via a power line 250.

Battery 210 is additionally configured to receive power from and be charged by PDS 206 via a power line 244. Further, battery 210 is additionally configured to provide power to PDS 206 via power line 244.

Each breaker in breaker bank 214 is configured to connect/disconnect one of DERs 212 or battery 210 from PDS 206. For example, breaker 222 is configured to connect/disconnect PVS 216 from distribution system 206. Breaker 224 is configured to connect/disconnect diesel generator 218 from distribution system 206. Breaker 226 is configured to connect/disconnect windmill 220 from distribution system 206. Breaker 225 is configured to connect/disconnect battery 210 from distribution system 206.

Each of the loads are configured to receive power from PDS 206. For example, load 205 is configured to receive power from PDS 206 via a power line 254, load 207 is configured to receive power from PDS 206 via a power line 256, load 209 is configured to receive power from PDS 206 via a power line 258, and load 211 is configured to receive power from PDS 206 via a power line 260.

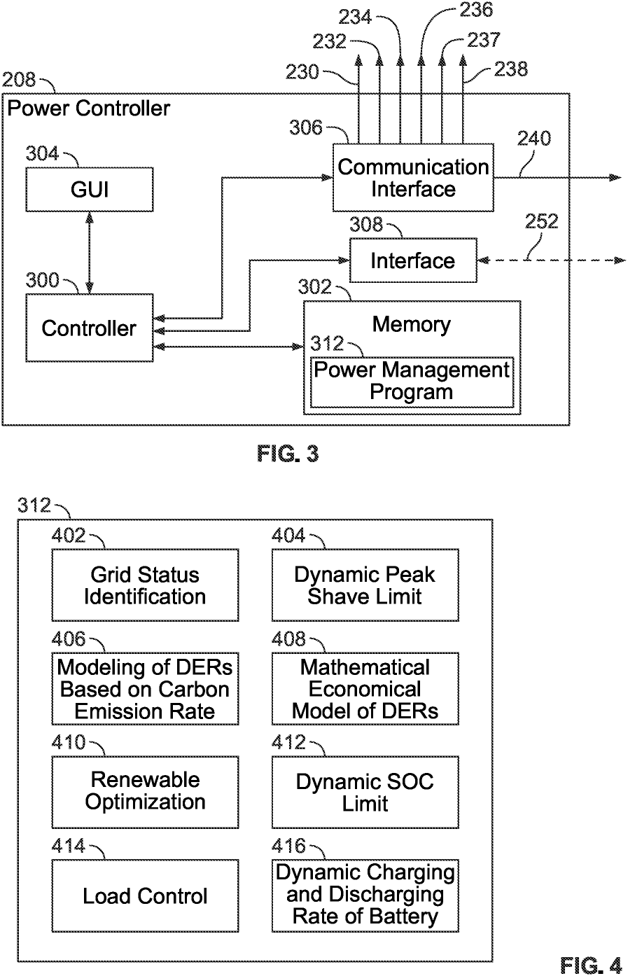

Power controller 208 will control the power distribution within microgrid 200. This will be described in greater detail with reference to FIG. 3.

FIG. 3 illustrates an exploded view of the power controller 208 of FIG. 2.

As shown in FIG. 3, power controller 208 includes a controller 300, a memory 302, a graphic user interface (GUI) 304, a communication interface 306, and an interface 308.

Controller 300 is configured to communicate with memory 302, with GUI 304, with communication interface 306, and with interface 308.

In this example, controller 300, memory 302, GUI 304, communication interface 306, and interface 308 are illustrated as individual devices. However, in some embodiments, at least two of controller 300, memory 302, GUI 304, communication interface 306, and interface 308 may be combined as a unitary device. Whether as individual devices or as combined devices, controller 300, memory 302, GUI 304, communication interface 306, and interface 308 may be implemented as any combination of an apparatus, a system and an integrated circuit. Further, in some embodiments, at least one of controller 300, memory 302, GUI 304, communication interface 306, and interface 308 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may be also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Controller 300 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of the power controller 208 in accordance with the embodiments described in the present disclosure.

Memory 302 can store various programming and data, including load history data, an economic model of PVS 216, a degradation model of battery 210, and power management program 312. As will be described in greater detail below, in some embodiments, power management program 312 includes instructions, that when executed by controller 300 cause power controller 208 to: determine a dynamic peak shaving limit based on the load history data so as to have a first peak shave limit during a first period and to have a second peak shave limit during a second period; control battery 210 to have a dynamic state of charge (SOC) limit so as to have a first SOC limit during a third period and to have a second SOC limit during a fourth period; in a first mode of operation, transmit a power instruction signal to the PVS 216 to cause PVS 216 to provide the amount of power to PDS 206 to cause PDS 206 to provide the amount of power to a load, based on the dynamic peak shave limit and the dynamic SOC limit; and in a second mode of operation, transmit the power instruction signal to battery 210 to cause battery 210 to provide the amount of power to PDS 206 to cause PDS 206 to provide the amount of power to the load, based on the dynamic peak shave limit and the dynamic SOC limit.

As will be described in greater detail below, in some embodiments, when used with a second load, power management program 312 includes instructions, that when executed by controller 300 cause power controller 208 to: establish a load curtailment time period; determine whether a current time is within the curtailment time period; and transmit the curtailment instruction signal to PDS 206 to cause PDS 206 to not provide the second amount of power to the second load, when the current time is within the curtailment time period.

As will be described in greater detail below, in some embodiments, when PVS 216 is configured to have an online status or an offline status, the online status enabling PVS 216 to operate in a PVS charging mode or a PVS discharging mode, the offline status not enabling PBS 216 to operate in either the PVS charging mode or PVS discharging mode, power management program 312 includes instructions, that when executed by controller 300 cause power controller 208 to: determine whether PVS 216 is in the online status or the offline status; and transmit the power instruction signal to battery 210 to cause battery 210 to provide the amount of power to PDS 206 to cause PDS 206 to provide the amount of power to the load, when PVS 216 is in the offline status.

As will be described in greater detail below, in some embodiments, when power controller 208 is configured for use with external grid 204, wherein external grid 204 is configured to provide power at an external power source cost, power management program 312 includes instructions, that when executed by controller 300 cause power controller 208 to: compare a cost of the amount of power from PVS 216 with the external power source cost; and transmit the power instruction signal to PVS 216 to cause PVS 216 to provide the amount of power to PDS 206 to cause PDS 206 to provide the amount of power to the load, when the cost of the amount of power from PVS 216 is less than the external power source cost.

As will be described in greater detail below, in some embodiments, when power controller 208 is configured for use with external grid 204, wherein external grid 204 is configured to provide power at an external power source cost, power management program 312 includes instructions, that when executed by controller 300 cause power controller 208 to: compare the cost of degradation of battery 210 with the external power source cost; and transmit the power instruction signal to battery 210 to cause battery 210 to provide the amount of power to PDS 206 to cause PDS 206 to provide the amount of power to the load, when the cost of the degradation of battery 210 is less than the external power source cost.

As will be described in greater detail below, in some embodiments, power management program 312 includes instructions, that when executed by controller 300 cause power controller 208 to: compare a cost of the amount of power from PVS 216 with a cost of degradation of battery 210, the cost of the amount of power from PVS 216 being based on the economic model of PVS 216, the cost of degradation of battery 210 being based on the degradation model of battery 210; transmit the power instruction signal to PVS 216 to cause PVS 216 to provide the amount of power to PDS 206 to cause PDS 206 to provide the amount of power to the load, when the cost of the amount of power from PVS 216 is less than or equal to than the cost of degradation of battery 210; and transmit the power instruction signal to battery 210 to cause battery 210 to provide the amount of power to PDS 206 to cause PDS 206 to provide the amount of power to the load, when the cost of the amount of power from PVS 216 is greater than the cost of degradation of battery 210.

Communication interface 306 can include one or more connectors, such as RF connectors, or Ethernet connectors, and/or wireless communication circuitry, such as 5G circuitry and one or more antennas. Communication interface 306 is arranged to: communicate with battery 210 via communication channel 230; to communicate with breaker 222 via communication channel 234; to communicate with breaker 224 via communication channel 236; to communicate with breaker 225 via communication channel 237; to communicate with breaker 226 via communication channel 238; to communicate with PDS 206 via communication channel 240, and to communicate with DERs 212 via communication channel 232. It should be noted that communication channel 232 is a plurality of distinct communication channels, each configured to communicate with a single respective DER within DERs 212. However, to simplify the figure, a single communication channel 232 is illustrated.

Interface 308 can include one or more connectors, such as RF connectors, or Ethernet connectors, and/or wireless communication circuitry, such as 5G circuitry and one or more antennas. In embodiments wherein power controller 208 is in communication with external server 203, interface 308 may send and/or receive data from external server by known methods, non-limiting examples of which include terrestrial antenna, satellite dish, wired cable, DSL, optical fibers, or 5G. Through interface 308, power controller 208 may receive an input signal from external server 203 and can send data to external server 203 via communication channel 252.

GUI 304 may be any device or system that is configured to enable a user to access and control controller 300. GUI 304 may include one or more layers including a human-machine interface (HMI) machines with physical input hardware such a keyboards, mice, game pads and output hardware such as computer monitors, speakers, and printers. Additional UI layers in GUI 304 may interact with one or more human senses, including: tactile UI (touch), visual UI (sight), and auditory UI (sound).

In operation, controller 300 will execute instructions in power management program 312 to control battery 210, the breakers in breaker bank 214, DERs 212, and PDS via communication interface in accordance with aspects of the present disclosure. This control will be based on multiple parameters that may be set and modified within microgrid 200. In some embodiments, these parameters may be set and modified by a user within facility 202 via 304. In some embodiments, these parameters may be set and modified by a user from outside facility 202 via external server 203. In particular a client device may perform this operation by operating an application configured to communicate with power controller via communication channel 252, or a server of a service provider may perform this operation by communicating with power controller via communication channel 252.

The instructions in power management program 312 may be described as modules, and will be described in greater detail with reference to FIG. 4.

FIG. 4 illustrates instruction modules within power management program 312, within memory 302 of power controller 208. As shown in the figure, power management program 312 includes: a grid status identification module 402; a dynamic peak shave limit determination and adjustments module 404; a modeling of DERs based on carbon emission rate module 406; a mathematical economical model of DERs module 408; a renewable optimization module 410; a dynamic SOC limits module 412; a load control module 414; and a rate of charge and discharge of battery module 416.

Grid status identification module 402 is responsible for determining whether an external grid is connected and providing power to the microgrid. Further, based on whether an external grid is connected and providing power to the microgrid, grid status identification module 402 includes instructions, that when executed by a processor in power controller 208, enable power controller 208 to determine what DER resources may be used to supplement power requirements for loads.

Dynamic peak shave limit determination and adjustments module 404 is responsible for determining the peak shave limit as discussed above (see S106 of FIG. 1).

With respect to the modeling of DERs based on carbon emission rate module 406, consider an example of a utility providing power to the microgrid. Typically, the overall power is a combination of the power provided by the utility in addition to the power provided by the DERs. In such a case, the emission rate of carbon as provided by the utility will be compared to the emission rate of carbon as provided by the DERs. Clearly a photovoltaic DER will provide less carbon emission. However a diesel generator DER might provide more carbon emission as that of the utility. With this in mind, the modeling of DERs based on carbon emission rate module 406 models the carbon emission of available power sources.

Mathematical economical model of DERs module 408 models economic aspects of all the DERs associated with the microgrid. Such aspects include the costs of generating electricity from each DER as a function of the cost of the DER plus the cost associated with maintaining the DER. For example, one economic model may include the cost of a photovoltaic system, the cost for maintenance of the photovoltaic system, the expected lifetime of the photovoltaic system, and the cost of replacement of the photovoltaic system. Further, the economic model may include a real time estimate of the amount of power to be generated by the photovoltaic system, e.g., the cost per KW/hr, in addition to a lifetime estimate of the amount of power to be generated by the photovoltaic system. Still further, the economic model may predict a net value of the electricity generated by the photovoltaic system based on the cost of electricity as provided by the utility. Therefore, the economic model of the photovoltaic system will include the predicted overall costs of the system in addition to the overall predicted value associated with electricity generated by the photovoltaic system.

Further, mathematical economical model of DERs module 408 models economic aspects of the battery the microgrid. This model includes the cost of the battery, the cost for maintenance of the battery, the expected lifetime of the battery, and the cost of replacement of the battery. With respect to the expected lifetime of the battery, the economic model includes a degradation model of the battery, which associated as cost in terms of money with each charge or discharge of the battery. This degradation model of the battery may be used to prioritize use of the battery to provide power to the microgrid in comparison to use DERs to provide power to the microgrid, or even to use the utility service to provide power to the microgrid.

Renewable optimization module 410 will optimize the use of the renewable DERs, such as photovoltaic systems and windmills, in the microgrid. In particular, renewable optimization module 410, prioritizes the user of renewable DERs, such as photovoltaic systems and windmills, to provide power to the microgrid, then moves to the battery to provide power to the microgrid, then moves to the utility service to provide power to the microgrid.

Dynamic SOC limits module 412 controls the SOC of the battery in the microgrid. The limit of the SOC of the battery may be changed based on application, such as peak shaving, carbon reduction or energy arbitrage, as will be described in greater detail below. In a non-limiting example, for energy arbitrage, a 25% reserve of the battery will be maintained. On the other hand, for peak shaving, the limit of the SOC will have a reserve of 20%. Finally, for carbon reductions, a 10% reserve of the battery will be maintained. However, with dynamic SOC limits module 412, these limits may be changed.

Load control module 414 enables curtailment of loads. For example, and for purposes of discussion, let the microgrid be deployed in a manufacturing facility that includes a plurality of large manufacturing machines, a heating/air conditioning system, and a lighting system. Further let there be various sub-systems. Load control module 414 would enable a controller to label some loads as critical loads and other loads as non-critical loads, wherein critical loads may not be subject to curtailment while non-critical loads may be subject to curtailment. Here, curtailment means disabling a load for predetermined periods of time to control the amount of power required by the microgrid. Load control module 414 would further enable the controller to curtail non-critical loads at configurable time periods, such as curtailing the large manufacturing machines from 8:00 pm to 8:00 am, when there are no workers present to operate the machines. By curtailing these loads during this time period, electricity will not be provided to the manufacturing machines.

Rate of charge and discharge of battery module 416 is similar to dynamic SOC limits module 412, but deals with the rate of charging and discharging of the battery within the microgrid. Rate of charge and discharge of battery module 416 would enable a controller to change charging/discharging rates of the battery based on: application, such as energy arbitrage, peak shaving and carbon reduction; time off day, such as peak/off peak hours; and the source of the power, whether from renewables or fossil fuels.

By executing instructions in power management program 312, controller 300 causes power controller 208 to perform the methods of controlling power to the microgrid in accordance with aspects of the present disclosure. Returning to FIG. 2, power controller 208 will control elements within microgrid 200 to optimize power generated by DERs and optimize the usage of battery 210. For purposes of discussion, let PDS 206 be connected external grid 204 via power line 228. In this case, external grid 204 is a utility that supplies power to PDS 206 as needed for loads within microgrid 200.

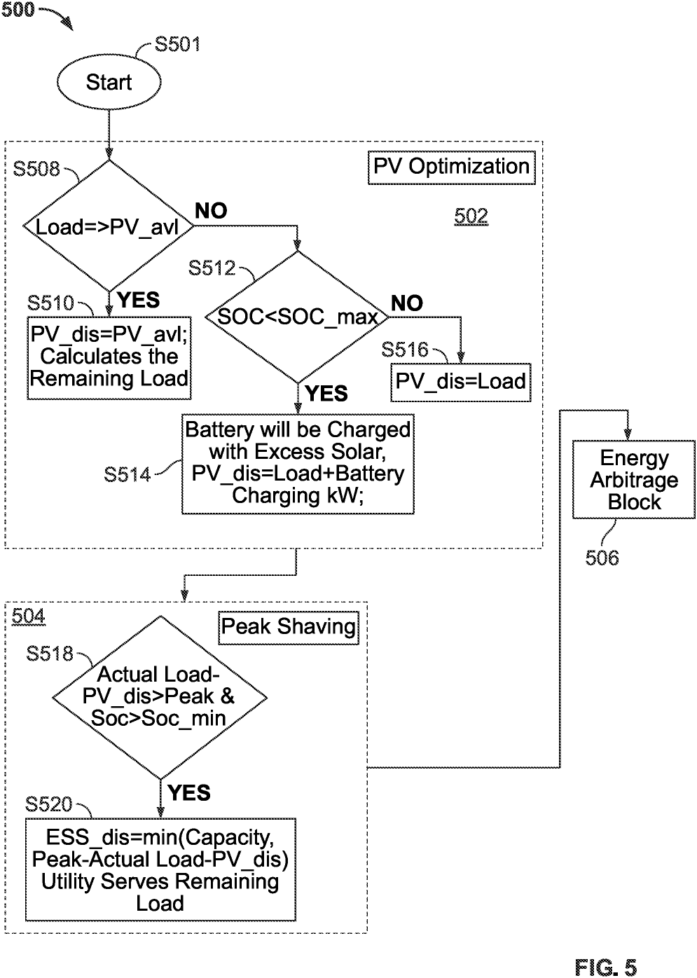

As will be described in greater detail below, power controller 208 will determine what power should be supplied to the loads within microgrid 200, wherein the available power supply may be provided by external grid 204, DERs 212, and battery 210. Power controller 208 will determine how much power to use from each of these sources in order to maximize use of power generated by DERs 212, optimize use of battery 210, and/or minimize the overall cost of the power. This will now be described in greater detail with reference to FIGS. 5-7.

FIG. 5 illustrates a portion of a more detailed example algorithm 500 to be executed by a processor to control power distribution within a microgrid in accordance with aspects of the present disclosure. For purposes of discussion, in the example algorithm 500, only power as provided by PVS 216 will be considered for use as a DER by PDS 206. Further, for purposes of discussion, in the example algorithm 500, PDS 206 will additionally be connected to, and able to receive power from, external grid 204.

As shown in the figure, algorithm 500 starts (S501) and a DER optimization process 502 is performed, which starts with a determination as to whether the power needed to supply a load is greater than or equal to the amount of power available from a DER (S508). For example, as shown in FIG. 2, suppose for purposes of discussion that the load to be supplied with power is only load 205, and let load 205 be a manufacturing machine. Further, let load 205 need 100 KW to operate for 1 hour. Additionally, in this example, let the DER be PVS 216.

As shown in FIG. 3, controller 300 will execute instructions in power management program 312 to cause communication interface 306 to access PVS 216 to determine the amount of power being generated by PVS 216.

Returning to FIG. 5, if it is determined that the power needed to supply a load is greater than or equal to the amount of power available from a DER (Yes at S508), then a dispatch instruction detailing how much power to be dispatched from the DER indicates that all the power provided by the DER should be discharged to the load (S510). For example, as shown in FIG. 2, a PVS dispatch instruction would indicate that all the power provided by PVS 216 should be provided to load 205.

As shown in FIG. 3, controller 300 will execute instructions in power management program 312 to generate a dispatch instruction that earmarks all the power generated by PVS 216 to be dispatched to load 205 at the end of algorithm 500. As will be described, before this power is actually dispatched to load 205 from PVS 216, the remainder of algorithm 500 will be performed. In this instance DER optimization process 502 is concluded and a peak shaving process 504 starts, which will be described later.

Returning to FIG. 5, if it is determined that the power needed to supply a load is less than the amount of power available from a DER (No at S508), then it is determined whether a state of charge (SOC) of the battery is less than a maximum SOC of the battery (S512). For example, as shown in FIG. 2, if the amount of power generated by PVS 216 is greater than the power needed by load 205, then something should be done with the excess power generated by PBS 216. In accordance with aspects of the present disclosure, the excess power may be used to charge battery 210. Before this happens, the SOC of battery 210 should be determined, as a fully charged battery cannot be additionally charges.

As such, as shown in FIG. 3, controller 300 will execute instructions in power management program 312 to cause communication interface 306 to access battery 210 to determine the whether the SOC of battery 210 is less than the maximum SOC of battery 210.

Returning to FIG. 5, if it is determined that the SOC of the battery is less than a maximum SOC of the battery (Yes at S512), then the dispatch instruction will instruct that the portion of power generated by the DER that is not used by the load will be diverted to the battery to charge the battery (S514). For example, as shown in FIG. 3, controller 300 will execute instructions to generate a dispatch instruction that earmarks the portion of the power generated by PVS 216, which is not earmarked for use by load 205, to be diverted to battery 210 at the end of algorithm 500. In this instance also, DER optimization process 502 is concluded and a peak shaving process 504 starts, which will be described later.

Returning to FIG. 5, if it is determined that the SOC of the battery is equal to the maximum SOC of the battery (No at S512), then the extra power will be sold to the utility or curtailed (S516). For example, as shown in FIG. 2, extra power generated by PVS 216 will be prioritized to first be consumed by load 205. If there is excess solar power after supplying power for load 205, then second priority is to charge battery 210. If there is excess solar power after supplying power for load 205 and charging battery 210, there are two options. In the first option, wherein net metering or selling power back to utility in charge of external grid 204, then excess power will be sold back to the utility in charge of external grid 204. In the second option, wherein net metering or selling power back to utility is not allowed, then the excess solar power will be curtailed. For example, let PVS 216 generate 100 kW, let load 205 be 50 kW, and let battery 210 have a SOC such that battery 210 is able to receive up to 30 kW of power to charge. In this case, the first 50 kW solar power from PVS 216 will go to load 205. After that, battery 210 will take 30 kW to be charged. Finally, the remaining 20 kW will either go back to the utility in charge of external grid 204 if it is allowed, or else the remaining 20 kW will be curtailed.

In this instance also, DER optimization process 502 is concluded and peak shaving process 504 starts.

Returning to FIG. 5, at the start of peak shaving process 504, it is determined whether the load minus the dispatch is greater than the peak shaving limit and if the SOC is greater than a minimum SOC (S518). For example, as shown in FIG. 3, controller 300 will execute instructions to determine the value of the power indicated in the generated dispatch instruction (from either S110, S114 or S116 discussed above).

Controller 300 will also execute instructions to determine whether the value of the power indicated in the generated dispatch instruction is greater than the peak shaving limit. As mentioned previously, the peak shaving limit may be set by a user via GUI 304, or may be set by external server 203 via interface 308.

Controller 300 will also execute instructions to determine whether the SOC of battery 210 is greater than a minimum SOC of battery 210. The minimum SOC of battery 210 may be set by a user via GUI 304, or may be set by external server 203 via interface 308.

Returning to FIG. 5, if it is determined that the load minus the dispatch is greater than the peak shaving limit and if the SOC is greater than a minimum SOC (both conditions are true, Yes at S518), then peak shaving will be performed (S520). For example, as shown in FIG. 2, if load 205 and there is available SOC left on battery 210, then peak shaving will be performed using battery 210. In other words, the extra power in battery 210 will be used for load 205 so as to “shave” off the power required by external grid 204.

Returning to FIG. 5, in this instance, peak shaving process 505 is concluded and an energy arbitrage process 506 starts, which will be discuss later.

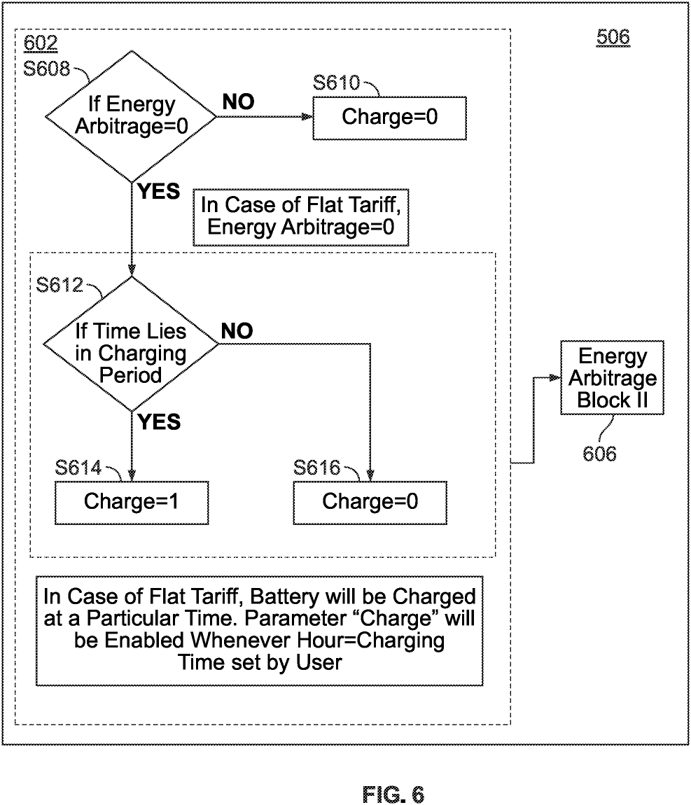

If it is determined that either the load minus the dispatch is not greater than the peak shaving limit or if the SOC is not greater than a minimum SOC (at least one of the conditions is false, No at S518), then peak shaving will not be performed and energy arbitrage process 506 starts. This will be described in greater detail with reference to FIG. 6.

FIG. 6 illustrates an exploded view of a first part 602 of energy arbitrage process 506. As shown in the figure, initially in first part 602, it is determined whether there is an energy tariff (S608). For example, as shown in FIG. 2, external grid 204 may supply power at a predetermined cost. However, in some cases, external grid 204 may add an energy tariff during certain periods of the day. In cases, where external grid 204 does add an energy tariff, the specifics of the tariff, such as amounts and times of the tariff, will be entered into power controller 208. In particular, as shown in FIG. 3, whether or not a tariff exists may be input into memory 302 either via GUI 304 or via external server 203 by way of interface 308. Further, if a tariff exists, the specifics of the tariff may additionally be input into memory 302 either via GUI 304 or via external server 203 by way of interface 308.

As such, controller 300 will execute instructions in power management program 312 to cause controller 300 to access memory 302 to determine whether there is an energy tariff.

Returning to FIG. 6, if it is determined that there is no tariff (No at S608), then the battery will be charged (S610). For example, as shown in FIG. 3, controller 300 will execute instructions in power management program 312 to instruct power controller 208 to charge battery 210.

Returning to FIG. 6, in this instance, first part 602 of energy arbitrage process 506 is concluded and a second part 606 of energy arbitrage process 506 starts.

However, if it is determined that there is a tariff (Yes at S608), then it is determined whether the current time is within the tariff time (S612). For example, as shown in FIG. 3, controller 300 will access memory 302 to determine the time that the tariff is to be in effect. Controller 300 then determines whether the current time is within the time that the tariff is to be in effect.

Returning to FIG. 6, if it is determined that the current time is during the time the tariff is to be in effect (Yes at S612), then the battery will be charged at a predetermined time outside of the time the tariff is to be in effect (S614). For example, as shown in FIG. 3, controller 300 will execute instructions in power management program 312 to instruct power controller 208 to charge battery 210 during a predetermined charging time. The predetermined charging time may be input into memory 302 either via GUI 304 or via external server 203 by way of interface 308.

Returning to FIG. 6, in this instance also, first part 602 of energy arbitrage process 506 is concluded and second part 606 of energy arbitrage process 506 starts. Alternatively, if it is determined that that the current time is not during the time the tariff is to be in effect (No at S612), then the battery will be charged (S616). This may be performed in a manner as discussed above (see S610). In this instance also, first part 602 of energy arbitrage process 506 is concluded and second part 606 of energy arbitrage process 506 starts.

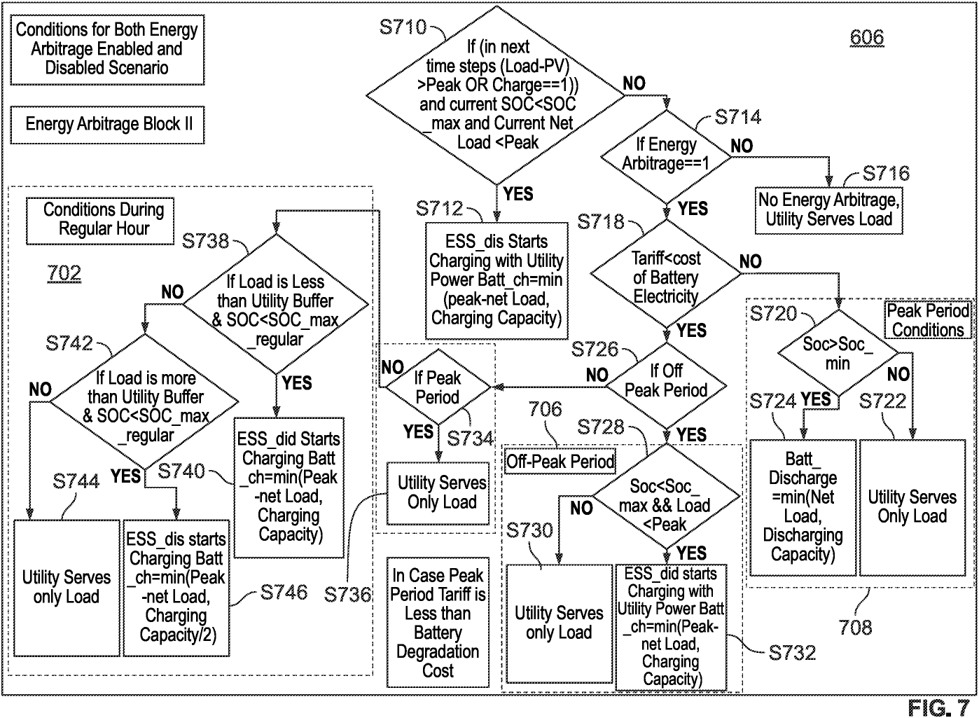

In first part 602, a determination is made as to whether to charge battery 210 from PVS 216. However, if battery 210 is to be charged from external grid 204, then second part 606 of energy arbitrage process will be performed. This will be described in greater detail with reference to FIG. 7.

FIG. 7 illustrates an exploded view of second part 606 of energy arbitrage process 506. As shown in the figure, initially in second part 602, it is determined whether: in the next time steps, the battery is set to be charged or the load minus the power provided by the DER is greater than the peak shaving value; and the current SOC of the battery is less than the maximum SOC of the battery; and the current load is less than the peak shaving value (S710). For example, as shown in FIG. 2, there are three conditions to be checked.

With respect to the first condition, it should be noted that algorithm 500 may be performed without any forecasting. However, if forecasting information is provided, it may be used. For example, without forecasting, algorithm 500 may take into account the current load 205. However, in some embodiments, the future of load 205 may be known. For example, in some cases, as shown in FIG. 3, power management program 312 may store information indicating that load 205 will be in effect from 8:00 am to 8:00 pm. In such cases, the future increments of load 205 will be known. In these cases, power controller 208 will determine whether, in these future steps, the load 205 minus the power provided by PVS 216 is larger than the peak shaving limit value or whether the battery is set to be charged by external grid 204, as determined above (S614).

With respect to the second condition, power controller 208 will additionally determine whether the SOC of battery 210 is less than the maximum SOC of battery 210, which is set in memory 302.

With respect to the third condition, power controller 208 will additionally determine whether the current load 205 is less than the peak shaving limit value.

Returning to FIG. 7, if it is determined that all three conditions are true (Yes at S710), then the battery is charged from power from the external grid (S712). For example, as shown in FIGS. 2-3, controller 300 will execute instructions in power management program 312 to instruct PDS 206 to charge battery 210 using power as provided by external grid 204. At this point, algorithm 500 stops.

Returning to FIG. 7, if it is determined that any of the three conditions are not true (No at S710), then it is determined whether energy arbitrage is to be performed (S714). For example as shown in FIG. 2, power controller 208 will determine whether there is an energy tariff. If there is no energy tariff, then energy arbitrage will not be performed.

Returning to FIG. 7, if it is determined that energy arbitrage is not to be performed (No at S716), then there is no energy arbitrage and the external grid serves the load (S716). For example, as shown in FIG. 3, controller 300 will execute instructions in power management program 312 to instruct PDS 206 to charge battery 210 using power as provided by external grid 204. At this point, algorithm 500 stops.

However, if it is determined that energy arbitrage is to be performed (Yes at S714), then it is determined whether the tariff is less than the cost of the electricity as provided by the battery (S718).

For example, as shown in FIG. 2, battery 210 has a charge that may be used to supply load 205. A person might say that this previously stored power is “free.” However, there is a cost associated with the charge in battery 210. That cost is determined based on the degradation model of battery 210. In particular, as a practical matter, battery 210 can only perform some indefinite number of charging/discharging cycles until battery 210 will need to be replaced. The replacement cost may be amortized over the life of battery 210. It is this amortization of the replacement cost of battery 210 that is in the degradation model of battery 210.

As shown in FIG. 3, the degradation model of battery 210 is stored in memory 302. Accordingly, controller 300 will execute instructions in power management program 312 to compare the tariff, as stored in memory 302, with the degradation cost of battery 210 as defined by the degradation model of battery 210 in memory 302. It should be noted that the tariff may change periodically. Such changes will be updated in memory 302.

Returning to FIG. 7, if it is determined that the tariff is not less than the cost of the battery (No at S718), then a peak period conditions process 708 is performed, wherein a determination is made as to whether SOC of the battery is greater than a minimum SOC of the battery (S720). For example, as shown in FIG. 3, a minimum SOC of the battery may be set in memory 302, as discussed previously. As shown in FIG. 2, power controller 208 will communicate with battery 210 to determine the current SOC of battery 210. As shown in FIG. 3, controller 300 will execute instructions in power management program 312 to compare the current SOC of battery 210 with the minimum SOC of battery 210, as stored in memory 302.

Returning to FIG. 7, if it is determined that the SOC of the battery is not greater than the minimum SOC of the battery (No at S720), then the external grid serves the load (S722). This may be performed in a manner as discussed above (see S716) and algorithm 500 stops. However, if it is determined that the SOC of the battery is greater than the minimum SOC of the battery (Yes at S720), then the battery is discharged to the load (S724). For example, as shown in FIG. 2, if there is more energy stored in battery 210 than the minimum amount that should be stored in battery 210, then the extra energy from battery 210 will be used to supply power to load 205. In such cases, as shown in FIG. 3, controller 300 will execute instructions in power management program 312 to instruct PDS 206 to discharge power from battery 210 to load 205 and algorithm 500 stops.

Returning to FIG. 7, if it is determined that the tariff is less than the cost of the battery electricity (Yes at S718), then it is determined whether it is an off peak period (S726). For example, as shown in FIG. 3, the peak period(s) and therefore off-peak period(s) are stored in memory 302 as discussed above. Controller 300 will execute instructions in power management program 312 to access memory 302 to determine whether the current time is during an off-peak period.

Returning to FIG. 7, if it is determined that it is during an off peak period (Yes at S726), then an off-peak period process 706 is performed, wherein initially a determination is made as to whether the SOC of the battery is less than a maximum SOC and whether the load is less than the peak shaving limit value (S728). For example, as shown in FIG. 2, power controller 208 will determine whether these two conditions are true.

Returning to FIG. 7, if it is determined that both conditions are true (Yes at S728), then the battery is charged with power from the external grid (S732). For example, as shown in FIG. 2, if the SOC of battery 210 is less than the maximum SOC of battery 210 then battery 210 may be charged to the maximum SOC. Further, if load 205 is less than the peak shaving limit value, then the extra power may be used to charge battery 210. As shown in FIG. 3, in such a case, controller 300 will execute instructions in power management program 312 to instruct PDS 206 to use power provided by external grid 204 to supply sufficient power to load 205 and supply the remaining power to charge battery 210, and algorithm 500 stops.

Returning to FIG. 7, if it is determined that either: the SOC of the battery is not less than a maximum SOC; or the load is not less than the peak shaving limit value (No at S728), then the external grid serves the load (S730). This may be performed in a manner as discussed above (see S716) and algorithm 500 stops.

If it is determined that it is not an off peak period (No at S726), then it is determined whether it is a peak period (S734). For example, as shown in FIG. 3, the peak period(s) and therefore off-peak period(s) are stored in memory 302 as discussed above. Controller 300 will execute instructions in power management program 312 to access memory 302 to determine whether the current time is during peak period.

Returning to FIG. 7, if it is determined to be a peak period (Yes at S734), then the external grid serves the load (S736). There may be instances where external grid 204 provides tariffs based on a peak period, a regular period, and a non-peak period - essentially a three tier tariff scheme. At this stage of algorithm 500 (after S734), it is a peak period, but the tariff is still relatively low. In such a case, it is not economical to charge battery 210 with power from external grid 204 or to use any power from battery 210 for load 205. This may be performed in a manner as discussed above (see S716) and algorithm 500 stops.

However, if it is determined that it is not a peak period (No at S734), then a process 702 for determining conditions for a regular hour is performed, wherein, initially, a determination is made as to whether the load is less than a predetermined utility buffer and the SOC of the battery is less than a predetermined regular maximum SOC of the battery (S738).

For example, as shown in FIG. 2, power controller 208 will determine: whether load 205 is less than a predetermined buffer for power provided by external grid 204; and whether the SOC of battery 210 is less than a predetermined regular maximum SOC of battery 210. The predetermined regular maximum SOC of battery 210 is a value that is stored in memory 302, either via GUI 304 or via external server 203. The maximum SOC of battery 210 is the maximum amount battery 210 may be charged from PVS 216 or from external grid 204. Generally, speaking the maximum SOC of battery 210 is about 95-100%. On the other hand, the predetermined regular maximum SOC of battery 210 is a value in which battery 210 is charged during a regular period that has a tariff. Although the tariff during a regular period is not as high as a tariff in a peak period, it is still a tariff. As such, at this time it is not economical to fully charge battery 210 because the power from external grid 204 is still slightly expensive. Accordingly, battery 210 is charged to a lesser amount than the maximum SOC. This lesser amount is the predetermined regular maximum SOC of battery 210.

The predetermined buffer for power provided by external grid 204 is a value that is stored in memory 302, either via GUI 304 or via external server 203. The predetermined buffer for power provided by external grid 204 is a value for guaranteed amount of power provided by external grid 204. For example, a customer of external grid 204 may want to establish that 40 KW of power will always be supplied from external grid 204. This guaranteed power may be set to cover at least critical loads. If such a predetermined buffer exists, it will have been stored in memory 302, either via GUI 304 or via external server 203. Further, controller 300 may execute instructions in power management program 312 to access memory 302 to obtain the value of the predetermined buffer.

Returning to FIG. 7, if it is determined that the load is less than a predetermined utility buffer and the SOC of the battery is less than a predetermined regular maximum SOC of the battery (Yes at S738), then the battery may be charge during a regular period (S740). For example, in the event that load 205 is less than the guaranteed amount of power that is provided by external grid 204 as defined by the buffer, then the excess power may be used to charge battery 210. In such cases, controller 300 will obtain the maximum charging rate for battery 210 and the maximum charging capacity of battery 210 from memory 302. Controller 300 will then execute instructions in power management program 312 to instruct PDS 206 to use power provided by external grid 204 to charge battery 210 at the maximum charging rate to a maximum capacity, and algorithm 500 stops.

Returning to FIG. 7, if it is determined that the load is not less than a predetermined utility buffer or the SOC of the battery is not less than a predetermined regular maximum SOC of the battery (No at S738), then it is then determined whether the load is more than the utility buffer and the SOC of the battery is less than the predetermined regular maximum SOC of the battery (S742). For example, as shown in FIG. 2, power controller 208 will determine: whether load 205 is more than the predetermined buffer for power provided by external grid 204; and whether the SOC of battery 210 is less than the predetermined regular maximum SOC of battery 210.

Returning to FIG. 7, if it is determined that the load is more than the utility buffer and the SOC of the battery is less than the predetermined regular maximum SOC of the battery (Yes at S742), then the battery may be charged during a regular period (S746). However, in this case, battery 210 is charged at a lower rate and to a lower capacity than as compared to the previous situation (see S740). For example, this lower charging rate of battery 210 may be set at one half the rate of the charging rate in the previous situation (see S740). Further, the lower charging capacity of battery 210 may be set at one half the rate of the charging rate in the previous situation (see S740). In such cases, controller 300 will obtain the decreased charging rate and the decreased charging capacity of battery 210 from memory 302. Controller 300 will then execute instructions in power management program 312 to instruct PDS 206 to use power provided by external grid 204 to charge battery 210 at the decreased charging rate and to the decreased charging capacity, and algorithm 500 stops.

However, if it is determined that either the load is not more than the utility buffer or the SOC of the battery is not less than the predetermined regular maximum SOC of the battery (No at S742), then the external grid serves the load (S744). This may be performed in a manner as discussed above (see S716) and algorithm 500 stops.

Algorithm 500 discussed above is described with a single load, load 205. It should be noted that algorithm 500 may be performed with any number of loads.

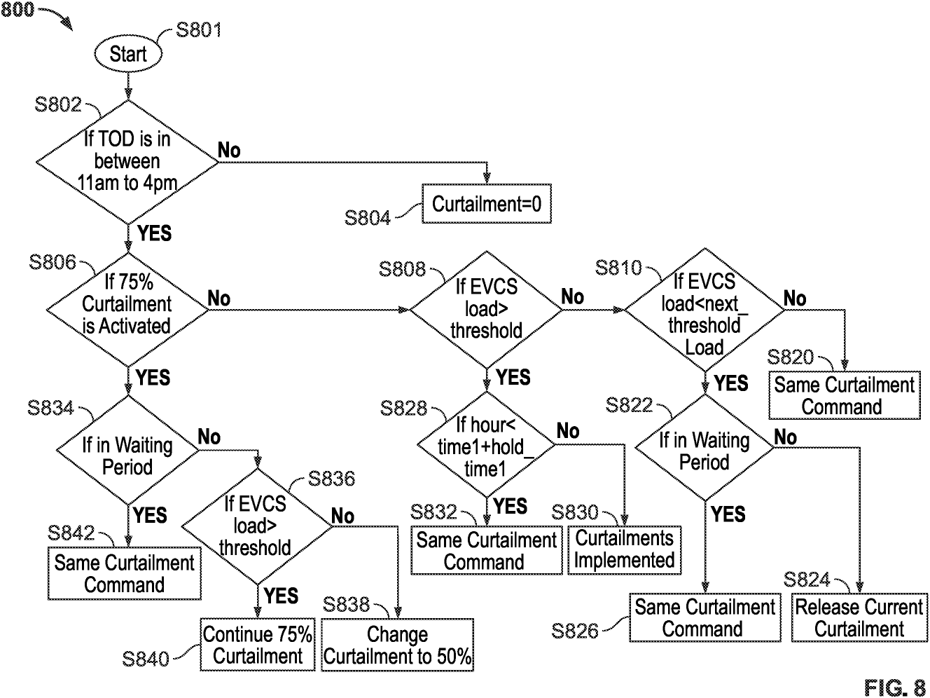

As mentioned previously, another aspect of the present disclosure is optimizing power use by curtailing predetermined loads. This will be described in greater detail with reference to FIG. 8.

FIG. 8 illustrates an example load control algorithm 800 to be executed by a processor to control power distribution within a microgrid in accordance with aspects of the present disclosure.

As shown in the figure, algorithm 800 starts (S801) and a determination is made as to whether the current time of day is between 11 AM and 4 PM (S802). In this non-limiting example, a curtailment period is set for between 11 AM and 4 PM. This means that during that time period, some non-critical loads may be curtailed, i.e., prevented from being used, in order to optimize power consumption. For example, as shown in FIG. 3, the curtailment period may be set in memory 302 via GUI 304 or via external server 203 by way of interface 308. Controller 300 may execute instructions in power management program 312 to access the curtailment period from memory 302 and determine whether the current time is during the curtailment period.

Returning to FIG. 8, if it is determined that the current time of day is between 11 AM and 4 PM (No at S802), then there is no curtailment (S804) and algorithm 800 stops. For example, as shown in FIG. 2, for purposes of discussion, in the case where there is no curtailment, let all of loads 205, 207, ..., 209 and 211 require power. If the current time is not between 11 AM and 4 PM then all the loads will be able to receive power.

Returning to FIG. 8, if it is determined that the current time of day is between 11 AM and 4 PM (Yes at S802), then it is determined whether a 75% curtailment is activated (S806). In this non-limiting example, an initial curtailment amount is set 75%. This means that 75% of non-critical loads may be curtailed, i.e., prevented from being used, in order to optimize power consumption. For example, as shown in FIG. 3, the initial curtailment amount may be set in memory 302 via GUI 304 or via external server 203 by way of interface 308. Controller 300 may execute instructions in power management program 312 to access the initial curtailment amount from memory 302.

Returning to FIG. 8, if it is determined that a 75% curtailment is not activated, then it is determined whether the required load is greater than a predetermined threshold (S808). In this non-limiting example, the curtailment of the loads is spread through three stages: a 75% curtailment stage; then if the required load is greater than a high threshold - meaning that some non-critical loads are needed, the curtailment drops to a 50% curtailment; and a default 25% curtailment stage if the required load is less than the high threshold, but above a second threshold- meaning that more non-critical loads are needed.

It should be noted that the three curtailment stages, and the respective curtailment amounts, are merely provided as examples. Any number of curtailment stages or curtailment amounts may be used in accordance with aspects of the present disclosure. Further, any curtailment amounts, and any requirements to initiate, or release them, may be stored in memory 302 via GUI 304 or via external server 203 by way of interface 308.

As shown in FIG. 3, the high threshold and the second threshold may be set in memory 302 via GUI 304 or via external server 203 by way of interface 308. Controller 300 may execute instructions in power management program 312 to access the high threshold and the second threshold from memory 302.

Returning to FIG. 8, if it is determined that the required load is not greater than the predetermined threshold (No at S808), then it is determined whether the required load is greater than a lower threshold load (S810). If it is determined that the required load is not greater than a lower threshold load (No at S810), then the 25% curtailment command is maintained (S820). For example, as shown in FIG. 2, consider for purposes of discussion that load 211 is a non-critical load and a microgrid 200 is currently operating a curtailment in which load 211 is curtailed. In such a case, power controller 208 would instruct power distribution system 206 to prevent load 211 from receiving power. This may be accomplished for example by electrically disconnecting load 211 via a breaker (not shown). In this situation, if this is the current curtailment, then at this stage of algorithm 800 (S820), load 211 will remain curtailed.

Returning to FIG. 8, if the current curtailment command is maintained (S820), then algorithm 800 stops. If it is determined that the required load is greater than a lower threshold load (Yes at S810), then it is determined whether the current time is in a waiting period (S822).

The waiting period is a predetermined period set in memory 302. The waiting period is a period of time that controller 300 will wait to release the current curtailment. As shown in FIG. 3, the waiting period may be set in memory 302 via GUI 304 or via external server 203 by way of interface 308. Controller 300 may execute instructions in power management program 312 to access waiting period from memory 302. Controller 300 may then execute instructions in power management program 312 to determine if the current time is during the waiting period, i.e., whether the waiting period has expired.

Returning to FIG. 8, if it is determined that the current time is not in a waiting period (No at S822), then the current curtailment is released (S824). For example, as shown in FIG. 2, consider again that load 211 is currently curtailed. If the waiting period has expired, then the curtailment of load 211 will be released such that load 211 may receive power.

Returning to FIG. 8, after the current curtailment is released (S824), algorithm 800 stops. If it is determined that the current time is in a waiting period (Yes at S822), then the current curtailment is maintained (S826) and algorithm 800 stops. This may be performed as discussed above (see S820). If it is determined that the required load is greater than the predetermined threshold (Yes at S808), then it is then determined whether a predetermined time has passed (S828).

As shown in FIG. 3, controller 300 may be configured to check the required load and current curtailment at predetermined intervals. This interval time may be set in memory 302 via GUI 304 or via external server 203 by way of interface 308. Controller 300 may execute instructions in power management program 312 to access the value of the interval from memory 302. After each interval, controller 300 may execute instructions in power management program 312 to determine whether the predetermined time has passed since it had last checked the required load and current curtailment.

Returning to FIG. 8, if it is determined that the predetermined time has passed (No at S828), then curtailments are implemented (S830) and algorithm 800 stops. For example, as shown in FIG. 2, power controller 208 implements the 25% curtailment.

Returning to FIG. 8, if it is determined that the predetermined time has not passed (Yes at S828), then then the current curtailment is maintained (S832) and algorithm 800 stops. This may be performed as discussed above (see S820). If it is determined that a 75% curtailment is activated (Yes at S806), then it is then determined whether the current time is during a waiting period (S834). This is similar to that as discussed above (see S822).

If it is determined that the current time is not in a waiting period (No at S834), then it is determined whether the load is greater than the predetermined threshold (S836). This is similar to that as discussed above (See S808). If it is determined that the load is not greater than the predetermined threshold (No at S836), then the curtailment is changed to 50% (S838). For example, and only for purposes of discussion, as shown in FIG. 2, let a curtailment of 50% mean that loads 211 and 209 are curtailed.

Returning to FIG. 8, after the curtailment is changed to 50% (S838), algorithm 800 stops. On the other hand, if it is determined that the load is greater than the predetermined threshold (Yes at S836), then the 75% curtailment is continued (S840). For example, and only for purposes of discussion, as shown in FIG. 2, let a curtailment of 75% mean that loads 207, 211, and 209 are curtailed.

Returning to FIG. 8, after the 75% curtailment is continued (S840), algorithm 800 stops. If it is determined that the current time is in a waiting period (Yes at S834), then the current curtailment is maintained (S842) and algorithm 800 stops. This may be performed as discussed above (see S820).

By performing algorithm 800, microgrid 200 is able to minimize power use and therefore save money.

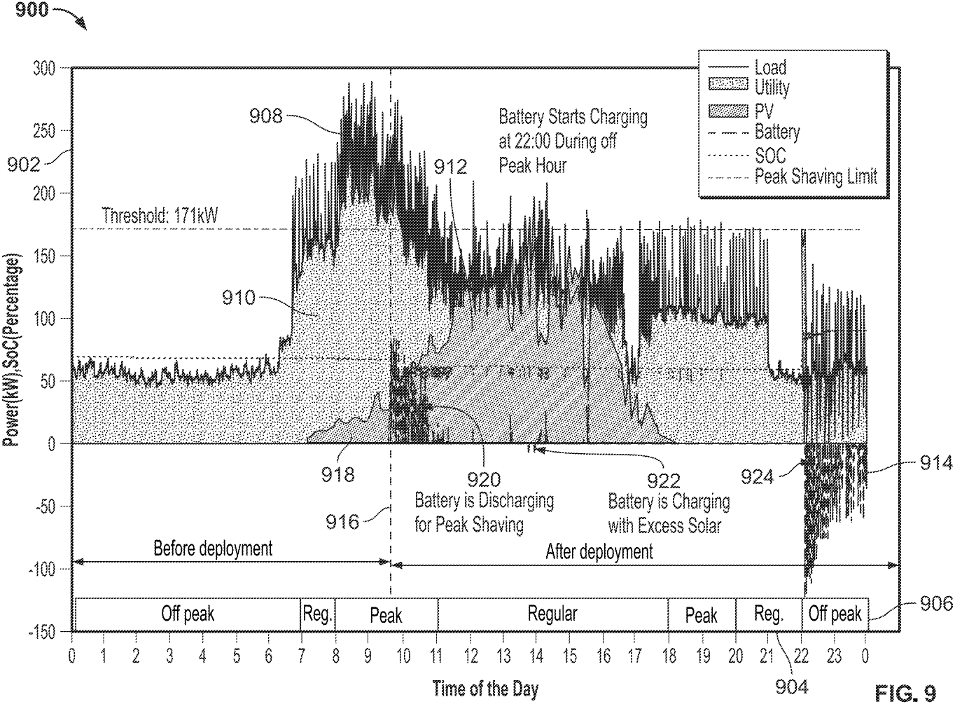

FIG. 9 illustrates a graph 900 detailing a field result test of a processor to control power distribution within a microgrid in accordance with aspects of the present disclosure.

As shown in the figure, graph 900 includes a y-axis 902 of power in KW, an x-axis 904 in hours of a day, a status bar 906, a function 908 of applied load, a function 910 of supplied power from a utility service, a function 912 of supplied power from a photovoltaic system, an area 914 of power supplied to charge a battery, and a deployment marker indicated by dotted line 916.

As further shown in the figure, the photovoltaic system starts generating power at around 7:00 AM as indicated by area 918. When the control system of the microgrid in accordance with the present disclosure is deployed around 10:00 AM, as indicated by dotted line 916, the battery starts discharging as indicated by area 920. At times throughout the day, power is provided to charge the battery as indicated by area 914, which includes spikes 922 and area 924. In particular, the battery is charged with excess power provided by the photovoltaic system during regular hours as indicated by spikes 922. The combination of the power provided by the discharging battery and the power provided by the photovoltaic system reduce the amount of power needed from the utility during the peak hours from 10:00 to 11:00 AM. Further, as shown in the off peak hours of 22:00-0:00, the battery is charged with power as provided from the utility as shown in area 924 of area 914.

A microgrid controller in accordance with aspects of the present disclosure uses a combination of dynamic SOC limits, dynamic charge/discharge rates, battery degradation cost and dynamic peak shave limits to identify the optimal set-points to optimally control load and generating sources while being independent of any external forecasting module.

By utilizing these configurable parameters, a microgrid controller in accordance with aspects of the present disclosure provides optimal savings ensuring reliable and sustainable operation.

The operations disclosed herein may constitute algorithms that can be effected by software, applications (apps, or mobile apps), or computer programs. The software, applications, computer programs can be stored on a non-transitory computer-readable medium for causing a computer, such as the one or more processors, to execute the operations described herein and shown in the drawing figures.

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

What is claimed is:

1. A power controller device for use with a battery, distributed energy resource (DER), a power distribution system (PDS), and a load, the battery being configured to operate in a battery charging mode so as to be charged by the DER and to operate in a battery discharging mode so as to discharge power to the PDS, the DER being configured to operate in a DER charging mode so as to charge the battery and to operate in a DER discharging mode so as to not charge the battery and being configured to discharge power to the PDS, the PDS being configured to provide an amount of power to the load, said power controller device comprising:
a memory having instructions, load history data, an economic model of the DER, and a degradation model of the battery stored therein; and
a processor configured to execute the instructions stored in said memory to cause said power controller device to:
determine a dynamic peak shaving limit based on the load history data so as to have a first peak shave limit during a first period and to have a second peak shave limit during a second period;
control the battery to have a dynamic state of charge (SOC) limit so as to have a first SOC limit during a third period and to have a second SOC limit during a fourth period;
in a first mode of operation, transmit a power instruction signal to the DER to cause the DER to provide the amount of power to the PDS to cause the PDS to provide the amount of power to the load, based on the dynamic peak shave limit and the dynamic SOC limit; and
in a second mode of operation, transmit the power instruction signal to the battery to cause the battery to provide the amount of power to the PDS to cause the PDS to provide the amount of power to the load, based on the dynamic peak shave limit and the dynamic SOC limit.

2. The power controller device of claim 1, for further use with a second load, wherein the PDS is further configured to provide a second amount of power to the second load, wherein said processor is configured to execute instructions stored on said memory to additionally cause said power controller device to:
establish a load curtailment time period;
determine whether a current time is within the curtailment time period; and
transmit a curtailment instruction signal to the PDS to cause the PDS to not provide the second amount of power to the second load, when the current time is within the curtailment time period.

3. The power controller device of claim 1, for further use with the DER being additionally configured to have an online status or an offline status, the online status enabling the DER to operate in the DER charging mode or the DER discharging mode, the offline status not enabling the DER to operate in either the DER charging mode or the DER discharging mode, wherein said processor is configured to execute instructions stored on said memory to additionally cause said power controller device to:
determine whether the DER is in the online status or the offline status; and
transmit the power instruction signal to the battery to cause the battery to provide the amount of power to the PDS to cause the PDS to provide the amount of power to the load, when the DER is in the offline status.

4. The power controller device of claim 1, for further use with an external power source, the external power source being configured to provide power at an external power source cost, wherein said processor is configured to execute instructions stored on said memory to additionally cause said power controller device to:
compare a cost of the amount of power from the DER with the external power source cost; and
transmit the power instruction signal to the DER to cause the DER to provide the amount of power to the PDS to cause the PDS to provide the amount of power to the load, when the cost of the amount of power from the DER is less than the external power source cost.

5. The power controller device of claim 1, for further use with an external power source, the external power source being configured to provide power at an external power source cost,
wherein said processor is configured to execute instructions stored on said memory to additionally cause said power controller device to:
compare a cost of degradation of the battery with the external power source cost; and
transmit the power instruction signal to the battery to cause the battery to provide the amount of power to the PDS to cause the PDS to provide the amount of power to the load, when the cost of degradation of the battery is less than the external power source cost, and
wherein the degradation model of the battery includes the cost of degradation of the battery.

6. The power controller device of claim 1, wherein said processor is configured to execute instructions stored on said memory to additionally cause said power controller device to:
compare a cost of the amount of power from the DER with a cost of degradation of the battery, the cost of the amount of power from the DER being based on the economic model of the DER, the cost of degradation of the battery being based on the degradation model of the battery;
transmit the power instruction signal to the DER to cause the DER to provide the amount of power to the PDS to cause the PDS to provide the amount of power to the load, when the cost of the amount of power from the DER is less than or equal to than the cost of degradation of the battery; and
transmit the power instruction signal to the battery to cause the battery to provide the amount of power to the PDS to cause the PDS to provide the amount of power to the load, when the cost of the amount of power from the DER is greater than the cost of degradation of the battery.

7. A method of using a power controller device with a battery, distributed energy resource (DER), a power distribution system (PDS), and a load, the battery being configured to operate in a battery charging mode so as to be charged by the DER and to operate in a battery discharging mode so as to discharge power to the PDS, the DER being configured to operate in a DER charging mode so as to charge the battery and to operate in a DER discharging mode so as to not charge the battery and being configured to discharge power to the PDS, the PDS being configured to provide an amount of power to the load, said method comprising:
determining, via a processor configured to execute instructions stored on a memory having the instructions, load history data, and an economic model of the DER stored therein, a peak shaving limit based on the load history data;
determining, via a processor configured to execute instructions stored on a memory having the instructions, a dynamic peak shaving limit based on the load history data so as to have a first peak shave limit during a first period and to have a second peak shave limit during a second period;
controlling, via the processor, the battery to have a dynamic state of charge (SOC) limit so as to have a first SOC limit during a third period and to have a second SOC limit during a fourth period;
in a first mode of operation, transmitting, via the processor, a power instruction signal to the DER to cause the DER to provide the amount of power to the PDS to cause the PDS to provide the amount of power to the load, based on the dynamic peak shave limit and the dynamic SOC limit; and
in a second mode of operation, transmitting, via the processor, the power instruction signal to the battery to cause the battery to provide the amount of power to the PDS to cause the PDS to provide the amount of power to the load, based on the dynamic peak shave limit and the dynamic SOC limit.

8. The method of claim 7, for further use with a second load, wherein the PDS is further configured to provide a second amount of power to the second load, said method further comprising:
establishing, via the processor, a load curtailment time period;
determining, via the processor, whether a current time is within the curtailment time period; and
transmitting, via the processor, a curtailment instruction signal to the PDS to cause the PDS to not provide the second amount of power to the second load, when the current time is within the curtailment time period.

9. The method of claim 7, for further use with the DER being additionally configured to have an online status or an offline status, the online status enabling the DER to operate in the DER charging mode or the DER discharging mode, the offline status not enabling the DER to operate in either the DER charging mode or the DER discharging mode, said method further comprising:
determining, via the processor, whether the DER is in the online status or the offline status; and
transmitting, via the processor, the power instruction signal to the battery to cause the battery to provide the amount of power to the PDS to cause the PDS to provide the amount of power to the load, when the DER is in the offline status.

10. The method of claim 7, for further use with an external power source, the external power source being configured to provide power at an external power source cost, said method further comprising:
comparing, via the processor, a cost of the amount of power from the DER with the external power source cost; and
transmitting, via the processor, the power instruction signal to the DER to cause the DER to provide the amount of power to the PDS to cause the PDS to provide the amount of power to the load, when the cost of the amount of power from the DER is less than the external power source cost.

11. The method of claim 7, for further use with an external power source, the external power source being configured to provide power at an external power source cost, said method further comprising:
comparing, via the processor, a cost of degradation of the battery with the external power source cost; and
transmitting, via the processor, the power instruction signal to the battery to cause the battery to provide the amount of power to the PDS to cause the PDS to provide the amount of power to the load, when the cost of degradation of the battery is less than the external power source cost,
wherein the degradation model of the battery includes the cost of degradation of the battery.

12. The method of claim 7, further comprising:
comparing, via the processor, a cost of the amount of power from the DER with a cost of degradation of the battery, the cost of the amount of power from the DER being based on the economic model of the DER, the cost of degradation of the battery being based on the degradation model of the battery;
transmitting, via the processor, the power instruction signal to the DER to cause the DER to provide the amount of power to the PDS to cause the PDS to provide the amount of power to the load, when the cost of the amount of power from the DER is less than or equal to than the cost of degradation of the battery; and
transmitting, via the processor, the power instruction signal to the battery to cause the battery to provide the amount of power to the PDS to cause the PDS to provide the amount of power to the load, when the cost of the amount of power from the DER is greater than the cost of degradation of the battery.

13. A non-transitory, computer-readable media having computer-readable instructions stored thereon, the computer-readable instructions being capable of being read by a power controller device for use with a battery, distributed energy resource (DER), a power distribution system (PDS), and a load, the battery being configured to operate in a battery charging mode so as to be charged by the DER and to operate in a battery discharging mode so as to discharge power to the PDS, the DER being configured to operate in a DER charging mode so as to charge the battery and to operate in a DER discharging mode so as to not charge the battery and being configured to discharge power to the PDS, the PDS being configured to provide an amount of power to the load, wherein the computer-readable instructions are capable of instructing the power controller device to perform the method comprising:
determining, via a processor configured to execute instructions stored on a memory having the instructions, load history data, and an economic model of the DER stored therein, a peak shaving limit based on the load history data;
determining, via a processor configured to execute instructions stored on a memory having the instructions, a dynamic peak shaving limit based on the load history data so as to have a first peak shave limit during a first period and to have a second peak shave limit during a second period;
controlling, via the processor, the battery to have a dynamic state of charge (SOC) limit so as to have a first SOC limit during a third period and to have a second SOC limit during a fourth period;
in a first mode of operation, transmitting, via the processor, a power instruction signal to the DER to cause the DER to provide the amount of power to the PDS to cause the PDS to provide the amount of power to the load, based on the dynamic peak shave limit and the dynamic SOC limit; and
in a second mode of operation, transmitting, via the processor, the power instruction signal to the battery to cause the battery to provide the amount of power to the PDS to cause the PDS to provide the amount of power to the load, based on the dynamic peak shave limit and the dynamic SOC limit.

14. The non-transitory, computer-readable media of claim 13, for further use with a second load, wherein the PDS is further configured to provide a second amount of power to the second load, wherein the computer-readable instructions are capable of instructing the power controller device to perform the method further comprising:
establishing, via the processor, a load curtailment time period;
determining, via the processor, whether a current time is within the curtailment time period; and
transmitting, via the processor, a curtailment instruction signal to the PDS to cause the PDS to not provide the second amount of power to the second load, when the current time is within the curtailment time period.

15. The non-transitory, computer-readable media of claim 13, for further use with the DER being additionally configured to have an online status or an offline status, the online status enabling the DER to operate in the DER charging mode or the DER discharging mode, the offline status not enabling the DER to operate in either the DER charging mode or the DER discharging mode, wherein the computer-readable instructions are capable of instructing the power controller device to perform the method further comprising:
determining, via the processor, whether the DER is in the online status or the offline status; and
transmitting, via the processor, the power instruction signal to the battery to cause the battery to provide the amount of power to the PDS to cause the PDS to provide the amount of power to the load, when the DER is in the offline status.

16. The non-transitory, computer-readable media of claim 13, for further use with an external power source, the external power source being configured to provide power at an external power source cost, wherein the computer-readable instructions are capable of instructing the power controller device to perform the method further comprising:
comparing, via the processor, a cost of the amount of power from the DER with the external power source cost; and
transmitting, via the processor, the power instruction signal to the DER to cause the DER to provide the amount of power to the PDS to cause the PDS to provide the amount of power to the load, when the cost of the amount of power from the DER is less than the external power source cost.

17. The non-transitory, computer-readable media of claim 13, for further use with an external power source, the external power source being configured to provide power at an external power source cost, wherein the computer-readable instructions are capable of instructing the power controller device to perform the method further comprising:
comparing, via the processor, a cost of degradation of the battery with the external power source cost; and
transmitting, via the processor, the power instruction signal to the battery to cause the battery to provide the amount of power to the PDS to cause the PDS to provide the amount of power to the load, when the cost of degradation of the battery is less than the external power source cost,
wherein the degradation model of the battery includes the cost of degradation of the battery.

18. The non-transitory, computer-readable media of claim 13, wherein the computer-readable instructions are capable of instructing the power controller device to perform the method further comprising:
comparing, via the processor, a cost of the amount of power from the DER with a cost of degradation of the battery, the cost of the amount of power from the DER being based on the economic model of the DER, the cost of degradation of the battery being based on the degradation model of the battery;
transmitting, via the processor, the power instruction signal to the DER to cause the DER to provide the amount of power to the PDS to cause the PDS to provide the amount of power to the load, when the cost of the amount of power from the DER is less than or equal to than the cost of degradation of the battery; and
transmitting, via the processor, the power instruction signal to the battery to cause the battery to provide the amount of power to the PDS to cause the PDS to provide the amount of power to the load, when the cost of the amount of power from the DER is greater than the cost of degradation of the battery.
